(19) United States
(12) Patent Application Publication
(10) Pub. No.: US 2013/0339441 A1
(43) Pub. Date: Dec. 19, 2013

(54) NETWORK SYSTEM WITH SHARING MECHANISM AND METHOD OF OPERATION THEREOF

(71) Applicant: Samsung Electronics Co., Ltd., Gyeonggi-Do (KR)

(72) Inventors: Phillip Vasquez, San Jose, CA (US); Anthony D. Hand, Campbell, CA (US); Robin D. Hayes, Castro Valley, CA (US); Gregory Dudey, Los Gatos, CA (US); Kuldip S. Pabla, San Jose, CA (US)

(73) Assignee: Samsung Electronics Co., Ltd., Gyeonggi-Do (KR)

(21) Appl. No.: 13/892,159

(22) Filed: May 10, 2013

Related U.S. Application Data
(60) Provisional application No. 61/646,206, filed on May 11, 2012.

(51) Int. Cl. H04L 29/08

(52) U.S. Cl. CPC H04L 67/306
USPC 709/204

(57) ABSTRACT

A network system includes: an initiation module configured to set up an event; a location identification module, coupled to the initiation module, configured to identify a participation location to the event; and a group module, coupled to the location identification module, configured to forming a device group at the participation location.

### CROSS-REFERENCE TO RELATED APPLICATION(S)

This application claims the benefit of U.S. Provisional Patent Application Ser. No. 61/646,206 filed May 11, 2012, and the subject matter thereof is incorporated herein by reference thereto.

### TECHNICAL FIELD

An embodiment of the present invention relates generally to a network system, and more particularly to a system for sharing.

### BACKGROUND

Modern consumer and industrial electronics, especially devices such as network systems, computing systems, televisions, projectors, cellular phones, smart phones, and combination devices, are providing increasing levels of functionality to support modern life including interconnecting to vast amount of information. Research and development in the existing technologies can take a myriad of different directions.

Many television program providers, cyber sports providers, and social network providers, support smart TVs, smartphones, tablets, PCs, digital photo frames, etc. Applications and platforms commonly use automated content recognition (ACR) to “listen” for audio from a source device to identify which program is playing, then cross reference the audio signature with from a cloud-based database.

Separately, gaming has become more of a social leisure activity. These social leisure activities are currently separated both by location and interest or target group. Based on current products and services, these activities continue to be separate and disparate. Social, consumer, technology, and business goals have developed these activities independently.

Thus, a need still remains for a network system with sharing mechanism to share a sport's experience across locations over disparate electronic devices. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a network system, including: an initiation module configured to set up an event; a location identification module, coupled to the initiation module, configured to identify a participation location to the event; and a group module, coupled to the location identification module, configured to forming a device group at the participation location.

An embodiment of the present invention provides a method of operation of a network system including: setting up an event with a control unit; identifying a participation location to the event; and forming a device group at the participation location.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a network system with sharing mechanism in an embodiment of the present invention.

FIG. 2 is an exemplary block diagram of the network system.

FIG. 3 is a control flow of the network system.

FIG. 4 is a control flow of the group module.

FIG. 5 is a control flow of the monitor module.

FIG. 6 is a flow chart of a method of operation of a network system in an embodiment of the present invention.

### DETAILED DESCRIPTION

An embodiment of the present invention provides a network system for improved interaction experience for an event over multiple participation locations by bundling devices into a device group at each of the participation locations. The device group can be used to simplify the management of the event by managing the device group as a single unit as opposed to many discrete devices.

An embodiment of the present invention provides a network system for simplified management of the event by designating one of the devices in the device group for each of the participation locations as a primary device and the other devices as participating devices. The host of the event can simplify the management of the event across all the participation locations by offloading some of the management of the event to the primary device for each of its respective partition location.

An embodiment of the present invention provides a network system for improved the experience of the event by utilizing the hardware and software features as well as the capabilities of the participating devices in the device group for each of the participation locations. The network system 100 can also redistribute the features for any of the participating devices that leave the device group to the rest of the participating devices remaining in the device group.

An embodiment of the present invention provides a network system for seamless management of the event in the case where the primary device is no longer available in the device group at one of the participation locations. The network system 100 designates one of the participating devices in the device group as the primary device to provide the main coordination function for the device group.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

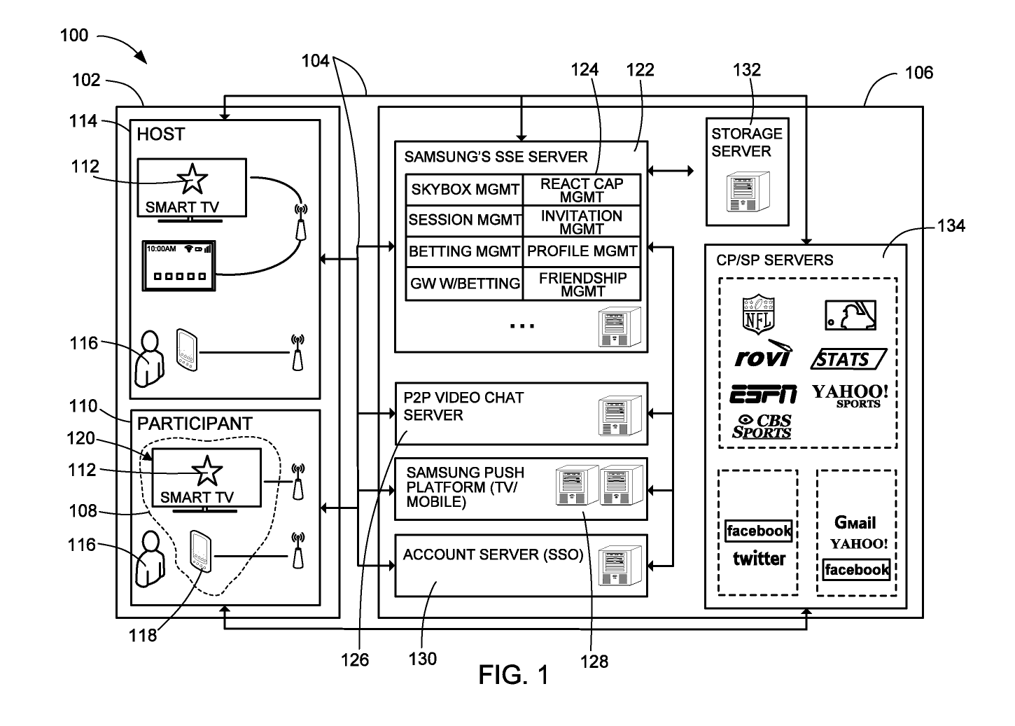

Referring now to FIG. 1, therein is shown a network system 100 with sharing mechanism in an embodiment of the present invention. The network system 100 includes first devices 102, such as client devices or a servers, connected to second devices 106, such as client devices or servers. The first devices 102 can communicate with the second devices 106 with a communication path 104, such as a wireless or wired network.

For example, the first devices 102 can be of any of a variety of devices, such as a cellular phone, a personal digital assistant, a notebook computer, a smart phone, a computer tablet, a multi-functional display, a television, or an entertainment device. The first devices 102 can couple, either directly or indirectly, to the communication path 104 to communicate with the second devices 106 or can be stand-alone devices.

For illustrative purposes, the network system 100 is described with the first devices 102 as mobile devices, although it is understood that the first devices 102 can be different types of devices. For example, the first devices 102 can also be a non-mobile or a stationary device, such as a server, a desktop computer, or cloud computing.

One of the first devices 102 can be paired to another of the first devices 102 enabling communication between these devices. The first devices 102 can be treated as a device group 108 at participation locations 110 for an event 112.

The event 112 is a shared activity across the participation locations 110. As an example, the event 112 can be a shared sporting event where the participants at the participation locations 110 can interact with each other for the event 112. As a further example, the event 112 can be an on-line collaboration event where the participants at the participation locations 110 can interact with each other.

Each of the participation locations 110 is a physical geographic region where participants at the location can be enabled to take part in the event 112. The activities, privileges, or interactions for each of the participation locations 110 can differ from one another or can be uniform across all the participation locations 110.

The device group 108 is collection of some or all the first devices 102 at each of the participation locations 110. The device group 108 can be formed differently at each of the participation locations 110 or can be formed uniformly across all the participation locations 110.

One of the participation locations 110 can be a host 114 for the event 112 and the other locations of the participation locations 110 can be event participants 116. The host 114 creates or initiates the event 112 for the event participants 116 to take part in the event 112. The event participants 116 take part in the event 112 through the authorization by the host 114.

At each of the participation locations 110, one of the first devices 102 in the device group 108 can act as a primary device 120 for that location and the other devices can act as participating devices 118. The primary device 120 takes the main coordination role among the devices in the device group 108 for its respective location of the participation locations 110. The participating devices 118 take part in the event 112 managed by the primary device 120. The selection of the first devices 102 in the device group 108 can change as to which one functions as the primary device 120.

For illustrative purposes, the device group 108 is described as a grouping of the first devices 102 in each of the participation locations 110, although it is understood that the device group 108 can be configured differently. For example, the device group 108 can include devices of different types, such as mobile, non-mobile or servers, or televisions. Further for example, there can also be devices at the particular location of the participation locations 110 that is not part of the device group 108, such as not authorized devices or accessories. Not all devices in the device group 108 at the particular location of the participation locations 110 can be eligible to be the primary device 120, such as a device accessory (not shown), such as a disc player or a human interface device (mouse or keyboard).

The second devices 106 for the embodiment of the present invention can include a number of servers providing a number of functions for the event 112. For example, one of the second devices 106 can be a management server 122. The management server 122 can provide a number of management functions 124 for the event 112. One of the second devices 106 can be a chat server 126 allowing the participation locations 110 to interact with each other through text, audio, images, video, or a combination thereof. Another of the second devices 106 can include a content server 128 to push content for the event 112 to the device group 108 that have been authorized by the host 114. Yet another of the second devices 106 can include an account server 130 allowing participants at the participation locations 110 to login into the event 112 initiated by the host 114.

Continuing with the types of functions provided by the second devices 106, the second devices 106 can also include a storage server 132 providing a reservoir of storage devices for the event 112, the network system 100, or a combination thereof. The second devices 106 can also include content provider servers 134 providing content, statistics, and other information as information sources for the event 112.

The second devices 106 can be any of a variety of centralized or decentralized computing devices, or transmission devices. For example, the second devices 106 can be a computer, a laptop computer, a desktop computer, a video game console, grid-computing resources, a virtualized computer resource, cloud computing resource, routers, switches, peer-to-peer distributed computing devices, a media playback device, a recording device, such as a camera or video camera, or a combination thereof. In another example, the second devices 106 can include a signal receiver for receiving broadcast or live stream signals, such as a television receiver, a cable box, a satellite dish receiver, or a web enabled device.

The second devices 106 can be centralized in a single room, distributed across different rooms, distributed across different geographical locations, embedded within a telecommunications network. The second devices 106 can couple with the communication path 104 to communicate with the first devices 102.

For illustrative purposes, the network system 100 is described with the second devices 106 as an end-point computing device, although it is understood that the second devices 106 can be different types of devices. Also for illustrative purposes, the network system 100 is shown with the second devices 106 and the first devices 102 as end points of the communication path 104, although it is understood that the network system 100 can have a different partition between the first devices 102, the second devices 106, and the communication path 104. For example, the first devices 102, the second devices 106, or a combination thereof can also function as part of the communication path 104.

The communication path 104 can span and represent a variety of networks and a variety of network topologies. For example, the communication path 104 can include wireless communication, wired communication, optical, ultrasonic, or the combination thereof. Satellite communication, cellular communication, Bluetooth™, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

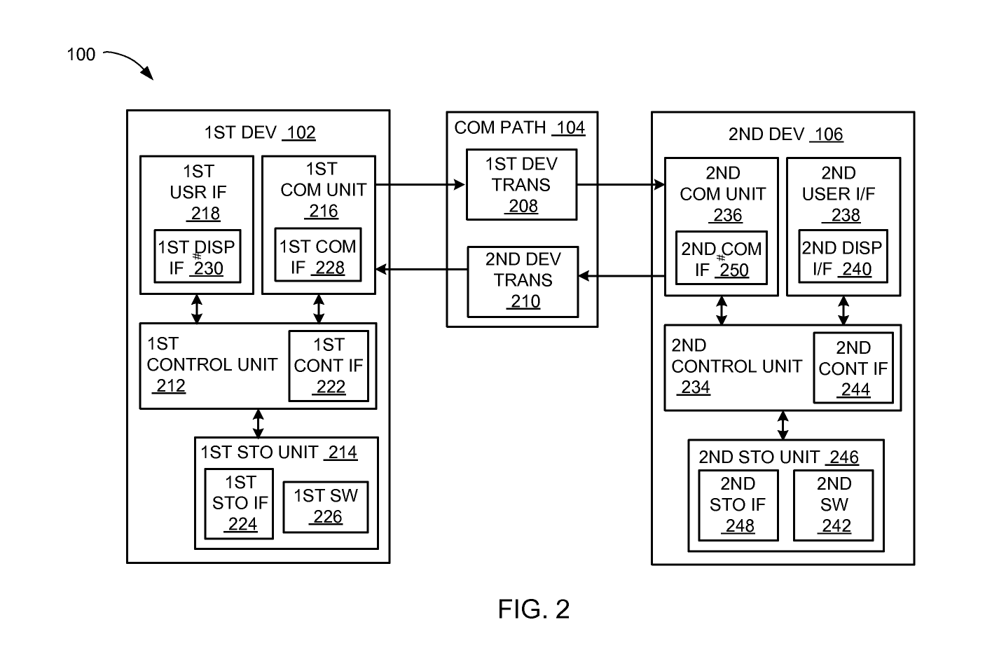

Referring now to FIG. 2, therein is shown an exemplary block diagram of the network system 100. The network system 100 can include the first devices 102, the communication path 104, and the second devices 106. The first devices 102 can send information in a first devices transmission 208 over the communication path 104 to the second devices 106. The second devices 106 can send information in a second devices transmission 210 over the communication path 104 to the first devices 102.

For illustrative purposes, the network system 100 is shown with the first devices 102 as a client device, although it is understood that the network system 100 can have the first devices 102 as a different type of device. For example, the first devices 102 can be a server having a display interface.

Also for illustrative purposes, the network system 100 is shown with the second devices 106 as a server, although it is understood that the network system 100 can have the second devices 106 as a different type of device. For example, the second devices 106 can be a client device.

For brevity of description in this embodiment of the present invention, the first devices 102 will be described as a client device and the second devices 106 will be described as a server device. The embodiment of the present invention is not limited to this selection for the type of devices. The selection is an example of an embodiment of the present invention.

The first devices 102 can include a first control unit 212, a first storage unit 214, a first communication unit 216, and a first user interface 218. The first control unit 212 can include a first control interface 222. The first control unit 212 can execute a first software 226 to provide the intelligence of the network system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first devices 102. The first control interface 222 can also be used for communication that is external to the first devices 102.

The first control interface 222 can receive information from the other functional units or from external sources, or can transmit information to the other functional units or to external destinations. The external sources and the external destinations refer to sources and destinations external to the first devices 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between and other functional units in the first devices 102. The first storage interface 224 can also be used for communication that is external to the first devices 102.

The first storage interface 224 can receive information from the other functional units or from external sources, or can transmit information to the other functional units or to external destinations. The external sources and the external destinations refer to sources and destinations external to the first devices 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first devices 102. For example, the first communication unit 216 can permit the first devices 102 to communicate with the second devices 106 of FIG. 1, an attachment, such as a peripheral device or a computer desktop, and the communication path 104.

The first communication unit 216 can also function as a communication hub allowing the first devices 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first devices 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first devices 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include a display, a projector, a video screen, a speaker, or any combination thereof.

The first control unit 212 can operate the first user interface 218 to display information generated by the network system 100. The first control unit 212 can also execute the first software 226 for the other functions of the network system 100. The first control unit 212 can further execute the first software 226 for interaction with the communication path 104 via the first communication unit 216.

The second devices 106 can be optimized for implementing an embodiment of the present invention in a multiple device embodiment with the first devices 102. The second devices 106 can provide the additional or higher performance processing power compared to the first devices 102. The second devices 106 can include a second control unit 234, a second communication unit 236, and a second user interface 238.

The second user interface 238 allows a user (not shown) to interface and interact with the second devices 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second devices 106 of the network system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the network system 100, including operating the second communication unit 236 to communicate with the first devices 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second devices 106. The second controller interface 244 can also be used for communication that is external to the second devices 106.

The second controller interface 244 can receive information from the other functional units or from external sources, or can transmit information to the other functional units or to external destinations. The external sources and the external destinations refer to sources and destinations external to the second devices 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the network system 100 is shown with the second storage unit 246 as a single hierarchy storage system, although it is understood that the network system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second devices 106. The second storage interface 248 can also be used for communication that is external to the second devices 106.

The second storage interface 248 can receive information from the other functional units or from external sources, or can transmit information to the other functional units or to external destinations. The external sources and the external destinations refer to sources and destinations external to the second devices 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second devices 106. For example, the second communication unit 236 can permit the second devices 106 to communicate with the first devices 102 over the communication path 104.

The second communication unit 236 can also function as a communication hub allowing the second devices 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second devices 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second devices 106 in the first devices transmission 208. The second devices 106 can receive information in the second communication unit 236 from the first devices transmission 208 of the communication path 104.

The second communication unit 236 can couple with the communication path 104 to send information to the first devices 102 in the second devices transmission 210. The first devices 102 can receive information in the first communication unit 216 from the second devices transmission 210 of the communication path 104. The network system 100 can be executed by the first control unit 212, the second control unit 234, or a combination thereof. For illustrative purposes, the second devices 106 is shown with the partition having the second user interface 238, the second storage unit 246, the second control unit 234, and the second communication unit 236, although it is understood that the second devices 106 can have a different partition. For example, the second software 242 can be partitioned differently such that some or all of its function can be in the second control unit 234 and the second communication unit 236. Also, the second devices 106 can include other functional units not shown in FIG. 2 for clarity.

The functional units in the first devices 102 can work individually and independently of the other functional units. The first devices 102 can work individually and independently from the second devices 106 and the communication path 104.

The functional units in the second devices 106 can work individually and independently of the other functional units. The second devices 106 can work individually and independently from the first devices 102 and the communication path 104.

For illustrative purposes, the network system 100 is described by operation of the first devices 102 and the second devices 106. It is understood that the first devices 102 and the second devices 106 can operate any of the modules and functions of the network system 100.

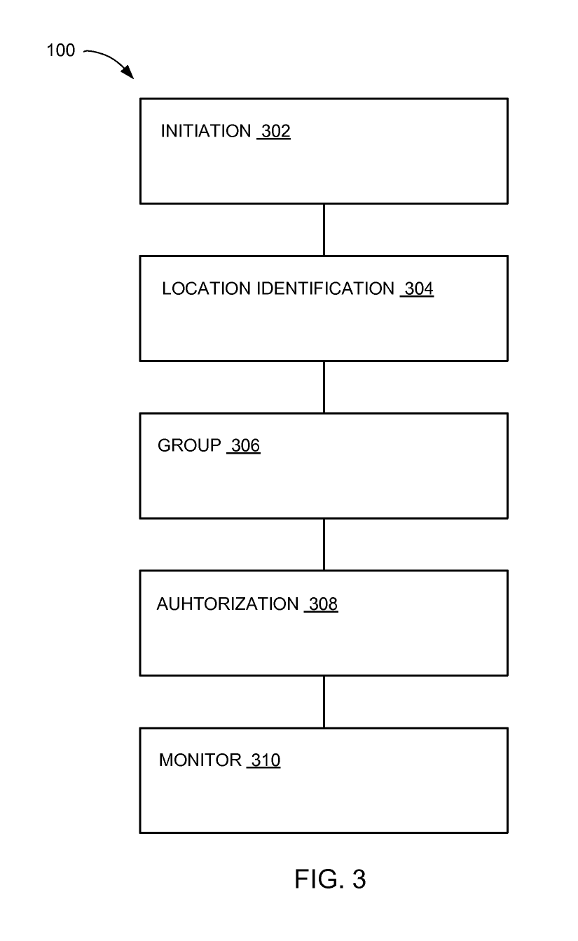

Referring now to FIG. 3, therein is shown a control flow of the network system 100. The network system 100 can include an initiation module 302, a location identification module 304, a group module 306, an authorization module 308, and a monitor module 310.

The modules can flow from one to another, as an example, as shown and described in this application. The control flow in this application can be linear or can also include feedback loops and iteration.

The initiation module 302 starts the event 112 of FIG. 1. The first control unit 212 of FIG. 2, the second control unit 234 of FIG. 2, or combination thereof can execute the initiation module 302. The host 114 of FIG. 1 can initiate, create, or setup the event 112 with the initiation module 302. The initiation module 302 can operate with the device group 108 of FIG. 1 as part of the host 114, the second devices 106 of FIG. 1, or a combination thereof. As a more specific example, the initiation module 302 can operate with the management server 122 of FIG. 1, the account server 130 of FIG. 1, the content provider servers 134 of FIG. 1. The initiation module 302 can operate with the event participants 116 of FIG. 1 as well as the host 114. The control flow can continue from the initiation module 302 to the location identification module 304.

The location identification module 304 identifies the locations of the participation locations 110 of FIG. 1 for the event 112. The location identification module 304 can identify the participation locations 110 in a number for ways. For example, the location identification module 304 can utilize the information from the account server 130, the management server 122, or a combination thereof. The account server 130 can provide login information from each of the participation locations 110 and provide location identification (not shown) to the management server 122, the location identification module 304, or a combination thereof. The flow can continue from the location identification module 304 to the group module 306.

The group module 306 can perform a multitude of functions for each of the participation locations 110. The group module 306 determines or forms the device group 108 of FIG. 1, optimizes the experience of the event at that particular location of the participation locations 110, or a combination thereof. Details of the group module 306 will be described later.

If two or more devices are participating in one of the participation locations 110, such as a skybox, and simultaneously present at the same physical location, the group module 306 bundles up the participating devices 118 into a single “smart group” referred to as the device group 108. The device group 108 can be managed as a unit for the purposes of sharing device resources, hardware and software features and services, and securely managing certain user access and privileges within a skybox and the larger social network. The group module 306 can operate with the management server 122 of FIG. 1 and the account server 130 of FIG. 1. The control flow can continue from the group module 306 to the authorization module 308.

The authorization module 308 authenticates each of the participation locations 110 to take part of the event 112. The authorization module 308 also provides authentication and privileges for some or all the first devices 102 of FIG. 1 in the device group 108 for taking part in the event 112. The privileges can be the same for all the first devices 102 in the device group 108 or can be different. The similarities or differences can be based on the operation of the authorization module 308 with the group module 306, the monitor module 310, or a combination thereof. The authorization module 308 can provide fine grained control so that the primary device 120 or the host 114 can enable or disable access for each group member through the participating devices 118 or the entire group as a whole to specific features of the skybox, such as participating in the video pool, using their device as a remote control, accessing text chat features, and so on.

As an example, the host 114, the primary device 120, or a combination thereof can grant access to features in one or more of the first devices 102 in the device group 108 even though those features are not specifically associated with the event 112. Examples of these features can be locking the volume control on a television as one of the first devices 102 in the device group 108 or locking the channel on the television to prevent changing the channel. Other examples of these features can include allowing at least some of the first devices 102 in the device group 108 push content to the television or to mirror a mobile device in the device group 108 to the television.

The authorization module 308 can encapsulates user credentials for one or more registered users on the participating devices 118, current device-specific settings, as well as potentially user-specific device preferences. On certain brand or types of the participating devices 118, it is possible for the event 112 with a social network and the skybox to access user credentials and device settings without further verification, or with minimal additional verification, per the user's preferences. Especially on certain older device types, such as televisions, such an encapsulation of owner credentials and device settings, together with access to such data by individual applications such as the sporting event social network and skybox, was not possible.

On the primary device 120, for example, the sporting event social network and skybox can use the owner credentials and device settings information to enhance the overall user experience for any device owners present in the device group 108 (e.g., a smart TV can have multiple registered owners, administrators, or other users). Also, the owner credentials and device settings on the primary device 120 can simplify device owner's connection to the social network and skybox in a multi-device environment, simplify access to select device settings, and simplify collaboration features with the other owners of the participating devices 118.

The authorization module 308 can operate with the second devices 106. As an example, the authorization module 308 can operate with the account server 130 for login of the participation locations 110. The control flow can continue from the authorization module 308 to the monitor module 310.

The monitor module 310 can provide a number for functions. The monitor module 310 tracks membership of the first devices 102 in the device group 108. The monitor module 310 also tracks the primary device 120 of FIG. 1, the participating devices 118 of FIG. 1, or a combination thereof. The monitor module 310 can operate with the group module 306 to update the membership of the first devices 102 in the device group 108, the participating devices 118, or a combination thereof. The monitor module 310 can also operate with the group module 306 to update the assignment of the primary device 120 from the device group 108. The details of the monitor module 310 will be described later.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the network system 100.

The network system 100 has been described with module functions or order as an example. The network system 100 can partition the modules differently or order the modules differently. For example, the location identification module 304, the group module 306, or a combination thereof can be part of the initiation module 302. Also for example, the monitor module 310 can have a feedback or loop back path to the group module 306.

The modules described in this application can be hardware implementation, hardware accelerators, or hardware circuitry in the first control unit 212 of FIG. 2 or in the second control unit 234 of FIG. 2. The modules can also be hardware implementation, hardware accelerators, or hardware circuitry within the first devices 102 or the second devices 106 but outside of the first control unit 212 or the second control unit 234, respectively.

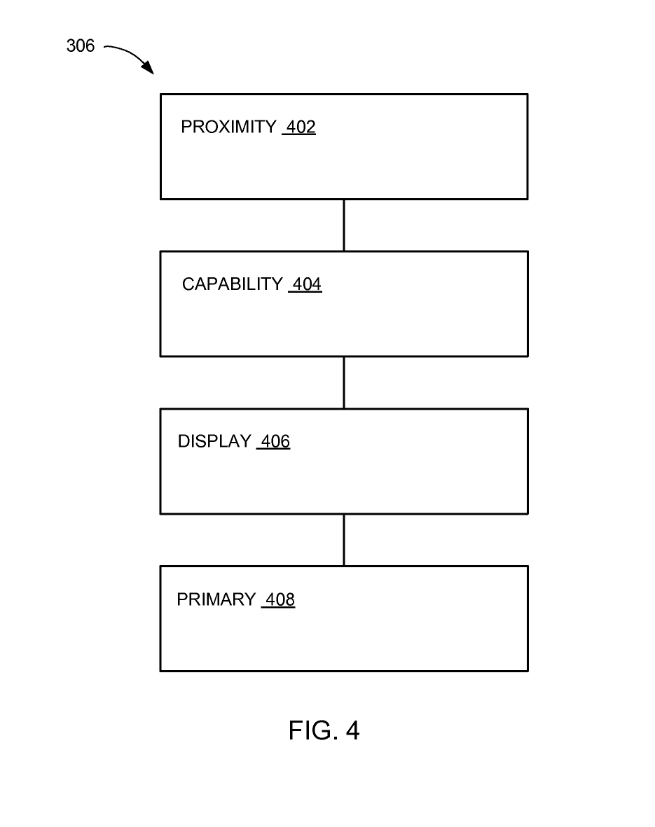

Referring now to FIG. 4, therein is shown a control flow of the group module 306. The group module 306 can include a proximity module 402, a capability module 404, a display module 406, and a primary module 408.

As described earlier, the group module 306 determines the device group 108 of FIG. 1, optimizes the experience of the event 112 of FIG. 1 at that particular location of the participation locations 110 of FIG. 1, or a combination thereof. If two or more devices are participating in one of the participation locations 110, such as a skybox, and simultaneously present at the same physical location, the group module 306 can bundle up the participating devices 118 into a single “smart group” referred to as the device group 108. The device group 108 can be managed as a unit for the event 112 and for the purposes of sharing device resources, hardware and software features and services, and securely managing certain user access and privileges within a skybox and the larger social network. The group module 306 can operate with the capability module 404 and will be described later.

The group module 306 can initially set one of the first devices 102 of FIG. 1 in the device group 108 for each of the participation locations 110 as the primary device 120 of FIG. 1 and the rest in the device group 108 as the participating devices of FIG. 1. It is possible that some of the participation locations 110 can have only the primary device 120 without any of the participating devices 118. The membership in the device group 108 can differ between the participation locations 110.

The group module 306 can determine the device group 108 with the proximity module 402, the primary module 408, or a combination thereof. The group module 306 can optimize the experience for the event 112 with the capability module 404, the display module 406, or a combination thereof. The group module 306 can enable the device group 108 for the event 112 with the proximity module 402, the capability module 404, the primary module 408, or a combination thereof.

The proximity module 402 determines which devices at each of the participation locations 110 are members in the device group 108. The proximity module 402 can determine the physical size or physical region for each of the participation locations 110.

For example, the proximity module 402 can determine which of the first devices 102 are nearby and within range. As a more specific example, the proximity module 402 can determine whether which of the first devices 102 are in the same room as the primary device 120 or within the same venue, depending on the type of the participation locations 110.

The proximity module 402 can determine whether devices are in range from the primary device 120 in a number of ways. For example, the proximity module 402 can determine proximity based on an estimation of distance from the detecting device or the primary device 120. The proximity module 402 can estimate distance for wireless and wired communication. The participation locations 110 can include both a wireless and wired environment or can be only one depending on the requirements as noted below.

For a wireless environment at the participation locations 110, the proximity module 402 can estimate distance and range based on the wireless strength between the primary device 120 and each of the participating devices 118. If the wireless strength is too weak, the device can be excluded as being one of the participating devices 118. If the wireless strength is strong, the device can be included as one of the participating devices 118. The estimation of distance, range, or a combination thereof can also be determined by the wireless bandwidth. If the event 112 requires or prefers a specific bandwidth for quality, devices that cannot achieve a minimum transfer bandwidth with the primary device 120, the host 114 of FIG. 1, or a combination thereof can be excluded from the participating devices 118. The estimation can also be through audible test sounds between the primary device 120 and the participating devices 118 in the device group 108. Otherwise, the device can be included as one of the participating devices 118.

For a wired environment or the wired portion of the environment at the participation locations 110, a local network in which the primary device 120 is a member and devices as part of the local network can be included as part of the participating devices 118. Similar to the wireless description earlier, if the event 112 requires or prefers a specific bandwidth for quality, devices that cannot achieve a minimum transfer bandwidth with the primary device 120, the host 114, or a combination thereof can be excluded from the participating devices 118. Otherwise, the device can be included as one of the participating devices 118.

The primary device 120, the host 114, or a combination thereof can monitor the proximity of the participating devices 118 within the device group 108. The primary device 120 can also request that each of the participating devices 118 activate its own instance of the proximity module 402 to determine the relative proximity of other devices within its area, and if available, report its location using an available indoor or outdoor positioning system compatible with the device.

As an example, when the proximity module 402 within the primary device 120 detects significant changes to the proximity for one of the participating devices 118, then the proximity module 402 can generate actions which can be used as signals to modify functionality or features within the event 112, or as a more specific example the sporting event social network, and the particular instance of the participation locations 110, such as a skybox, relative to the participating devices 118 and its registered user. The control flow can continue from the proximity module 402 to the capability module 404.

The capability module 404 gathers the hardware and software features and resources in the device group 108 determined by the proximity module 402 in order to optimize the end user experience. For example, in the living room of the house where Group A is participating in one of the participation locations 110, such as a skybox, the capability module 404 can detect a smart TV, several mobile phones, a smart tablet, and a Windows laptop.

As the skybox experience at each of the participation locations 110 can include one live video feed for the device group 108, the capability module 404 can optionally attempt to use the camera on the device from the device group 108 that provides the best view of the group of friends present in the living room. The control flow can continue from the capability module 404 to the display module 406.

The display module 406 can poll the video from the webcam on the smart TV, the webcam on the laptop, and the front facing cameras on other devices from the device group 108 to attempt to determine which device would provide the best picture of the group of friends at that moment in time and then switch the video feed to the selected device. Alternatively, the owner of the TV can set the video feed to a specific device, such as a laptop or tablet perched on a coffee table.

The display module 406 can determine which device from the device group 108 should provide the live video feed based on a number of factors. Examples of the factors can include counting faces to maximize the number of faces in the picture, the quality of the video given the available lighting, monitoring volume in the room, choosing a wider viewing angle for certain highly emotional events to capture more body language, monitoring for wild gesticulations of a hand holding the device and switching to a more stable device, periodically choosing a close up view especially when a user in the picture is talking and the face is clearly visible, or a combination thereof. The control flow can continue from the display module 406 to the primary module 408.

The primary module 408 determines if the designation as the primary device 120 to one of the first devices 102 of FIG. 1 from the device group 108 should be changed to another device in the device group 108. The primary module 408 can assess the initial assignment and the proximity of the devices in the device group 108.

For example, if the designation eliminates too many devices in the device group 108 based on performance metrics as described in the proximity module 402, then the primary module 408 can assign another device in the device group 108 as the primary device 120 and the control flow can loop back to the proximity module 402 to determine if the overall experience improves based on a different assignment. The overall experience can improve if more devices are included in the device group 108; the overall performance of the event 112 improves with increased bandwidth, or a combination thereof.

The primary module 408 can also designate a different device in the device group 108 as the primary device 120 if the primary device 120 previously designated is no longer part of the device group 108. The primary module 408 can factor the capabilities of each of the participating devices 118 in the device group 108. Generally speaking, the participating devices 118 having a stable power supply, stable Internet connection, and appropriate hardware and software capabilities, and the being generally stationary for the event 112 are factors to consider for the desired attributes for the primary device 120. The primary module 408 can also operate with and loop back to the proximity module 402 to ascertain the proximity, distance, and range of a candidate for the primary device 120 to the other participating devices 118 still part of the device group 108. The control flow can also continue from the primary module 408 to the authorization module 308 of FIG. 3 when there is no additional reassignment of the primary device 120.

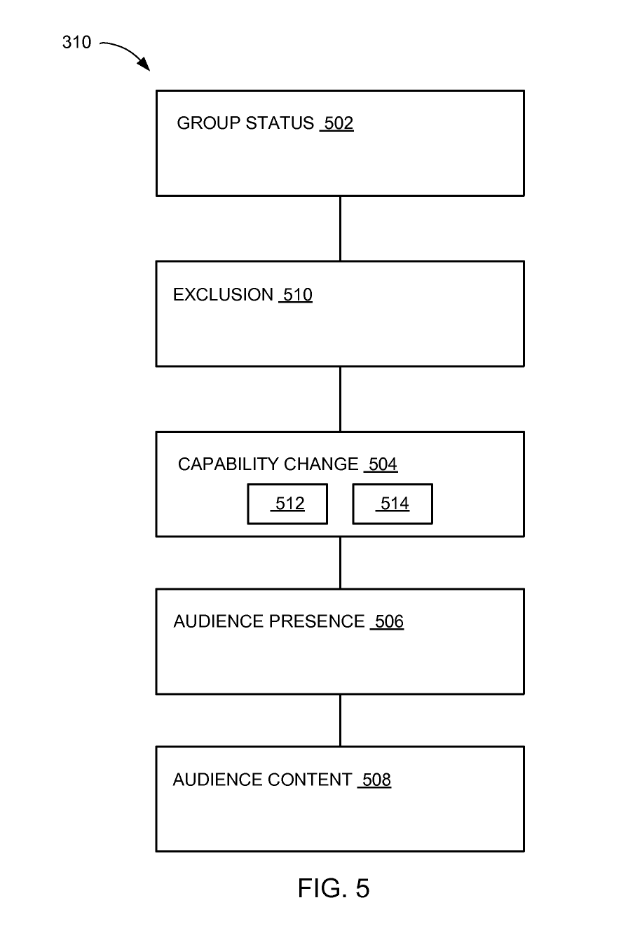

Referring now to FIG. 5, therein is shown a control flow of the monitor module 310. The monitor module 310 can include a group status module 502, a capability change module 504, an audience presence module 506, an audience content module 508, and an exclusion module 510.

The group status module 502 tracks membership of the first devices 102 in the device group 108. The group status module 502 can determines for each of the first devices 102 in the device group 108 is adequately delivering the acceptable performance for the event 112. Each of the devices in the device group 108 can determine if there is a required or preferred bandwidth between the primary device 120 and each of the participating devices 118. The group status module 502 can operate with the proximity module 402 of FIG. 4 to monitor any of the participating devices 118 in the device group 108 has moved beyond a maximum distance from the primary device 120 or falls below a performance threshold. If one or both of these conditions are true, the control flow can continue from the group status module 502 to the exclusion module 510.

The group status module 502 can also monitor a status of the primary device 120 in the device group 108. If the group status module 502 determines that the primary device 120 drops out of the device group 108 for some reason (e.g., leaves the premises, loses power, etc.), one of the other devices in the device group 108 or one of the participating devices 118 in the device group 108 can be promoted to and as the primary device 120.

The group status module 502 can initiate the determination of the new designation for the primary device 120 in a number of ways. For example, the group status module 502 can operate with the capability change module 504 to ascertain the totality of hardware and software features and resource remaining in the device group 108. This information can be passed to the primary module 408 of FIG. 4 for a new designation for the primary device 120.

The exclusion module 510 removes devices from the device group 108. The exclusion module 510 can remove a particular device as an active device in the device group 108. The exclusion module 510 can suspend that device's privileges to the event 112, the particular location of the participation locations 110 where the device group 108 is located, or a combination thereof.

The exclusion module 510 can interact with the primary device 120 for the device group 108. The exclusion module 510 can provide a message to appear on the screen of the device being excluded. The exclusion module 510 can also provide other types of alerts, such as an audible tone, a haptic feedback, or a combination thereof. The exclusion module 510 can also provide alerts to other users of the participating devices 118 in the device group 108, or within the associated skybox, notifying one or more of the participating devices 118 that the user has left the device group 108, the skybox, the event 112, or a combination thereof.

The exclusion module 510 can interact with the management server 122 of FIG. 1 or the account server 130 of FIG. 1 to suspend privileges. If one of the participating devices 118 that is being removed from the device group 108 also provides hardware or software collaboration features or functionality to the totality of the particular location of the participation locations 110, such as the skybox, then the control flow can continue to the capability change module 504, otherwise the control flow can continue to the audience content module 508.

The capability change module 504 can monitor available hardware and software features and resources in the device group 108 in order to continue to optimize the end user experience for each of the participation locations 110. Continuing from the exclusion module 510 where at least one of the participating devices 118 is removed from the device group 108, the capability change module 504 can detect the removal. If that particular device of the participating devices 118 being removed is actively providing hardware or software collaboration features or functionality to the totality from the device group 108, such as providing the live video feed of the group, then the change capability module 404, the primary device 120, or a combination thereof can determine that the shared features and functionality are no longer of sufficient quality to continue contributing to the totality of the skybox. As a result, the change capability module 404, the primary device 120, or a combination thereof can switch responsibilities for the previously shared features and functionality to another device from the participating devices 118 remaining in the device group 108.

Similarly, the capability change module 504 can monitor the totality of hardware and software features as resources in the device group 108 if the primary device 120 leaves the device group 108. The control flow can continue from the capability change module 504 to the primary module 408 of FIG. 4 of the group module 306 of FIG. 4.

The capability module 404 can monitor or periodically poll the video from the webcam on the smart TV, the webcam on the laptop, and the front facing cameras on other devices to attempt to detect which device would provide the best picture of the group of friends at that moment in time and then switch the video feed to the selected device. The control flow can continue from the capability module 404 to the audience presence module 506.

The capability module 404 can include a group management module 512 and a hardware management module 514. The group management module 512 manages the device group 108. The hardware management module 514 manages the operations of the devices in the device group 108.

The group management module 512 can improve the overall user experience at each of the participation locations 110 by the primary device 120 tracking which devices in the device group 108 is connected to the primary device 120. The group management module 512 can be within the primary device 120.

The group management module 512 can treat multiple distinct types of device classes differently in the user interface. For example, where some of the participating devices 118 could be considered proxies for individual users (e.g., a smartphone with a unique hardware address may be considered a proxy for the device's registered owner), the network system 100 can display the user's regular name; while other devices which are less likely to be considered proxies for an individual owner (such as a smart TV, which might be considered more of a shared resource by multiple users in the group) can be displayed with their machine name or hidden altogether from such areas as the chat room or group member list. The group management module 512 can operate with the authorization module 308 and be responsible for member verification, skybox invitations, accessing group member permission lists, etc., in partnership with its counterpart in the cloud.

The group management module 512 can be within the participating devices 118 in the device group 108. The group management module 512 can be responsible for resolving the device's hardware address and mapping it to the user's preferred display value, such as their name or an alias, and sharing such information with the primary device 120 and rest of the participating devices 118 in the device group 108. The group management module 512 can also be responsible for managing authentication, application settings, member permissions, etc., in partnership with its counterpart in the cloud.

Returning to the hardware management module 514, the hardware management module 514 can be within the primary device 120. The hardware management module 514 can be responsible for identifying and monitoring which hardware features are available on each of the participating devices 118 in the device group 108, permissions for accessing them, and managing the switchover of a given feature from one device to the next, among others.

If the primary device 120 allows the network system 100 or more specifically the hardware management module 514 to automatically optimize the overall skybox experience by automatically using any hardware and software features and functionality in the device group 108, then the hardware management module 514 also monitors the participating devices 118 and makes periodic decisions for switching devices, if necessary. The hardware management module 514 can consider factors such data points as the volume level of the sporting and the corresponding likely action (which may vary by sport), the quality of input (e.g., audio and/or video input), the wireless signal strength, the inherent capabilities of the type of wireless protocol being used (e.g., Bluetooth versus DLNA), sudden changes in the device's location in space according to its inertial sensors, sudden change in lighting according to a light sensor, and so on.

The hardware management module 514 can be within the participating devices 118. The hardware management module 514 can be responsible for identifying the device's capabilities, access permissions, etc. for the participating devices 118 in the device group 108 and reporting them to the primary device 120. The hardware management module 514 can also be responsible for routing access requests to the device's hardware and software features and functionality, providing access to the device's current state (such as location, accelerometer sensor data, etc.), identifying the device's capabilities per its supported wired and wireless protocols, and so on.

The audience presence module 506 helps ensures quality of experience to the participants at each of the participation locations 110. The audience presence module 506 can take into consideration factors such as proximity to the TV as one of the participating devices 118, the primary device 120, or a combination thereof and direct user interaction with the video feed. For example, if the user walks away from the TV to the bathroom or leaves the home entirely, the audience presence module 506 can automatically switch the video feed to another of the participating devices 118 in the device group 108. However, if the user walks away from the TV in order to, for example, conduct an interview with another user in the kitchen, then the audience presence module 506 can allow the device to continue providing the live video feed for the event 112. The control flow can continue from the audience presence module 506 to the audience content module 508.

The audience content module 508 monitors content from the participants of the event 112. For example, as a social sporting event in a user's home, where emotions can often run high and even friends can sometimes get rowdy, the audience content module 508 can operate with the authorization module 308 of FIG. 3 to provide features for the owner of the smart TV to monitor and control the access of the group members to certain features of the skybox and the smart TV itself. The smart TV can be operating as the primary device 120 or one of the participating devices 118, as examples.

The host 114, the primary device 120 at the particular location of the participation locations 110, or a combination thereof can always see which devices are part of the device group 108 and are connected to the skybox at any time, and which of the devices are sharing their hardware and software features and resources, if any. For example, if one of the group's member's devices is providing the video feed and making funny faces or being socially inappropriate, the host 114, the primary device 120, or a combination thereof can switch the feed to another device in the device group 108. The audience content module 508 can operate with the authorization module 308 to ban the user's device in the device group 108 from participating in the video feed pool for the rest of the event 112.

As noted earlier, the authorization module 308 can provide fine grained control to enable or disable access for each group member or the entire group as a whole to specific features of the skybox, such as participating in the video pool, using their device as a remote control, accessing text chat features, and so on. Also noted earlier, the authorization module 308 can provide the ability to grant access to other TV features not specifically associated with the skybox, such as locking the TV to the skybox view (thus preventing channel changing), allowing users to push multimedia content to the TV via Digital Living Network Alliance (DLNA), changing the TV volume, mirroring the contents of a mobile device on the TV, and so on.

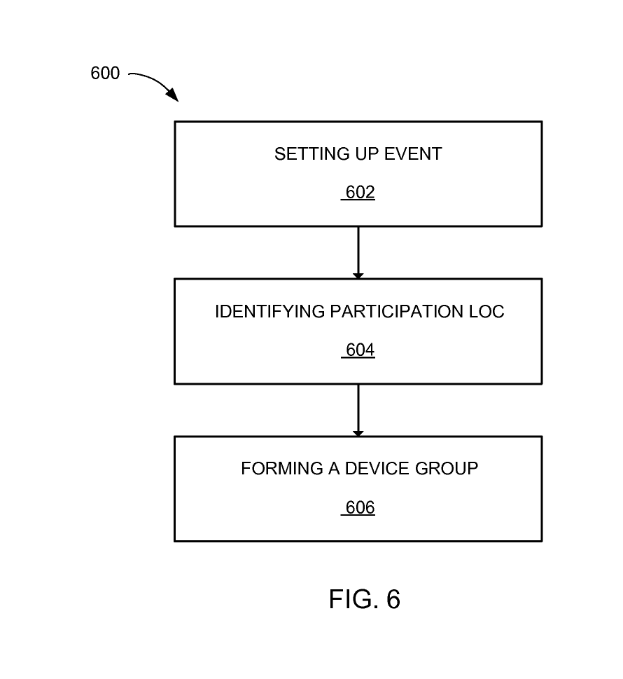

Referring now to FIG. 6, therein is shown a flow chart of a method 600 of operation of a network system 100 in an embodiment of the present invention. The method 600 includes: setting up an event with a control unit in a block 602; identifying a participation location to the event in a block 604; and forming a device group at the participation location in a block 606.

It has been discovered that the network system 100 provides improved interaction experience for an event over multiple participation locations by bundling devices into a device group at each of the participation locations. The device group can be used to simplify the management of the event by managing the device group as a single unit as opposed to many discrete devices.

It has been discovered that the network system 100 further simplifies management of the event by designating one of the devices in the device group for each of the participation locations as a primary device and the other devices as participating devices. The host of the event can simplify the management of the event across all the participation locations by offloading some of the management of the event to the primary device for each of its respective partition location.

It has been discovered that the network system 100 further improves the experience of the event by utilizing the hardware and software features as well as the capabilities of the participating devices in the device group for each of the participation locations. The network system 100 can also redistribute the features for any of the participating devices that leave the device group to the rest of the participating devices remaining in the device group.

It has been discovered that the network system 100 provides seamless management of the event in the case where the primary device is no longer available in the device group at one of the participation locations. The network system 100 designates one of the participating devices in the device group as the primary device to provide the main coordination function for the device group.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A network system comprising:
an initiation module configured to set up an event;
a location identification module, coupled to the initiation module, configured to identify a participation location to the event; and
a group module, coupled to the location identification module, configured to forming a device group at the participation location.

2. The system as claimed in claim 1 wherein the group module includes a primary module configured to designate a primary device for coordinating the device group.

3. The system as claimed in claim 1 wherein the group module includes a proximity module configured to identify a participating device is within range.

4. The system as claimed in claim 1 wherein the group module is configured to share device resources from the device group for the event.

5. The system as claimed in claim 1 further comprising an exclusion module, coupled to the group module, configured to remove a participating device from the device group.

6. The system as claimed in claim 1 further comprising an authorization module, coupled to the group module, configured to ban a participating device from the event.

7. The system as claimed in claim 1 wherein:
the group module includes a primary module configured to designate a primary device for coordinating the device group; and
further comprising:
a group status module, coupled to the group module, configured to designate a different device in the device group as the primary device.

8. The system as claimed in claim 1 further comprising a hardware management module, coupled to the group module, configured to monitor features in the device group.

9. The system as claimed in claim 1 wherein the group module is configured to bundle multiple devices at the participation location.

10. The system as claimed in claim 1 further comprising a capability change module, coupled to the group module, configured to:
detect a removal of a participating device from the device group; and
switch a shared feature from the participating device being removed to another instance of the participating device in the device group.

11. A method of operation of a network system comprising:
setting up an event with a control unit;
identifying a participation location to the event; and
forming a device group at the participation location.

12. The method as claimed in claim 11 wherein forming the device group includes designating a primary device for coordinating the device group.

13. The method as claimed in claim 11 wherein forming the device group includes identifying a participating device is within range.

14. The method as claimed in claim 11 further comprising sharing device resources from the device group for the event.

15. The method as claimed in claim 11 further comprising removing a participating device from the device group.

16. The method as claimed in claim 11 further comprising banning a participating device from the event.

17. The method as claimed in claim 11 wherein:
forming the device group includes designating a primary device for coordinating the device group; and
further comprising:
designating a different device in the device group as the primary device.

18. The method as claimed in claim 11 further comprising monitoring features in the device group.

19. The method as claimed in claim 11 wherein forming the device group at the participation location includes bundling multiple devices at the participation location.

20. The method as claimed in claim 11 further comprising:
detecting a removal of a participating device from the device group; and
switching a shared feature from the participating device being removed to another instance of the participating device in the device group.
